(19) United States
(12) Patent Application Publication
(10) Pub. No.: US 2026/0059317 A1
(43) Pub. Date: Feb. 26, 2026

(54) ATTACK DETECTION AT LOW SAMPLING RATE IN ROUND-TRIP TIMING ESTIMATION

(71) Applicant: Cypress Semiconductor Corporation, San Jose, CA (US)

(72) Inventors: Igor KOLYCH, Lviv (UA); Claudio REY, Chandler, AZ (US)

(73) Assignee: Cypress Semiconductor Corporation, San Jose, CA (US)

(21) Appl. No.: 18/812,115

(22) Filed: Aug. 22, 2024

(51) Int. Cl. H04W 12/121; H04L 43/0864; H04W 4/80

(52) U.S. Cl. CPC H04W 12/121; H04L 43/0864; H04W 4/80

(57) ABSTRACT

A wireless device includes a receiver adapted with Bluetooth® low energy (BLE) capability and logic at least one of coupled to or integrated within the receiver. The logic obtains, based on a received packet, a received signal. The logic identifies, based on the received signal and a reference signal, a fractional timing metric associated with the received signal. The logic calculates, based on the received signal, the reference signal, and an attack pattern, a correlation metric. The logic adjusts, based on the fractional timing metric, the correlation metric. The logic determines, based on the adjusted correlation metric and one or more thresholds, whether an attack is present in received signal.

### TECHNICAL FIELD

This disclosure relates to wireless networks and, more specifically, to attack detection at low sampling rate in round-trip timing (RTT) estimation.

### BACKGROUND

Personal area networks (PANs), such as Bluetooth® (BT), Bluetooth® Low Energy (BLE), Zigbee®, infrared, and the like, provide a wireless connection for various personal, industrial, scientific, and medical applications. PANs generally use a packet-based protocol and have an architecture that includes central devices (CDs) and peripheral devices (PDs). A CD can communicate with multiple PDs over the PAN.

Some PANs, such as those based on BLE technology, have communication ranges similar to BT networks but have considerably smaller power consumption and cost. Further, BLE devices often remain in a sleep mode and transition to an active mode when data communication is about to happen. BLE protocol also supports mesh networking, in which data can flow over multiple paths, and which does not rely on a rigid hierarchical structure of devices, often allowing the same devices to serve as CDs or PDs, depending on particular network conditions and topology.

Additionally, some PANs are used in wireless devices (e.g., CDs) that are included in or associated with lock mechanisms of enclosures (such as a residence, a vehicle, a garage, a shed, or the like) and used to provide secure keyless access to persons in possession of a keyed PD, e.g., also referred to as keyless entry. The wireless CD device, which may also include or be coupled with a mobile device, may transmit a particular data pattern within a frame delimiter of a packet using BLE distance estimation technology. A keyed PD (which could be a mobile device such as a smartphone, for example) may estimate arrival time and return a particular data pattern within a frame delimiter of a packet using BLE distance estimation technology, e.g., in order to estimate round-trip timing (RTT) of packets. The wireless CD device may estimate an arrival time of the returned packet. The wireless devices may perform frame synch detection to verify that the particular data pattern matches an expected data pattern used to, in part, provide a level of security to the keyless entry based on distance ranging. This RTT-based ranging is susceptible to attack at least partially due to being able to be spoofed in certain ways of measuring, including a ranging technique.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A is a block diagram of a system useable for improving attack detection at low sampling rate in RTT estimation, according to at least one embodiment.

FIG. 1B is a simplified block diagram of the communication interface of a wireless device, according to at least one embodiment.

FIG. 2 is a simplified graph illustrating the frequency of a transmitted signal over time containing attack and expected signal, according to at least one embodiment.

FIG. 3A is a simplified graph illustrating the frequency of an attack pattern signal over time, according to at least one embodiment.

FIG. 3B is a simplified graph illustrating the frequency of an attack pattern signal over time that is oversampled, according to at least one embodiment.

FIG. 4A is a graphical representation of approximation of a set of training data used in improving attack detection at low sampling rate in RTT estimation, according to at least one embodiment.

FIG. 4B is a graphical representation of an adjustment of the correlation metrics using the approximation of FIG. 4A, according to at least one embodiment.

FIG. 5 is a flow diagram of a method of improving attack detection at low sampling rate in RTT estimation, according to at least one embodiment.

FIG. 6 is a flow diagram of a method of improving attack detection at low sampling rate in RTT estimation, according to at least one embodiment.

### DETAILED DESCRIPTION

The following description sets forth numerous specific details such as examples of specific systems, devices, components, methods, and so forth, in order to provide a good understanding of various embodiments of frame synchronization detection between wireless devices associated with a PAN. The disclosed principles may generally be applied to (Gaussian) Frequency Shift Keying ((G)FSK) modulation or (Binary) Phase Shift Keying ((B)PSK) modulation. Frame synchronization (or frame synch) detection may refer to detecting a frame delimiter, also referred to as a start frame delimiter (SFD), in a network packet identifying or signaling that data is to follow within a frame of the packet.

In certain PAN devices, frame synchronization detection can be used to aid in communication between wireless devices by identifying or signaling the data (i.e., payload data) that is to follow in a packet. Optionally, frame synchronization can also identify the sender of the packet. In certain PAN devices, frame synchronization or frame synchronization with data can be used as part of BLE distance estimation. BLE distance estimation is achieved through a phase-based distance ranging method, through packet exchanges in round trip timing (RTT) estimation, or a combination thereof to provide localization between wireless devices. In one example, data patterns (e.g., a sequence of digital “Os” and “Is”) are used in RTT estimation to estimate the time of arrival (ToA) of a packet, and data patterns are used in RTT estimation to estimate the time of departure (ToD) of a packet. In another example, BLE distance estimation can use the frequency estimated during the RTT estimation to synchronize the BLE distance estimation device to other BLE distance estimation devices through the correction of clocking errors and to estimate the frequency offset between devices. Additionally, BLE distance estimation can use data patterns to estimate frequency for use in security features, such as attack detection (or intrusion detection) models. As such, there is a need for improved security features for BLE distance estimation devices.

As discussed previously, RTT-based ranging techniques used for security applications (e.g., location tracking using BLE RTT) can be vulnerable to spoofing attacks. Attackers employing various techniques like finite impulse response (FIR) filters, early commit late detect (ECLD)/early detect late commit (EDLC), and Amplitude Modulation (AM) which can impersonate legitimate devices. FIR filters alter specific frequencies within the RTT packet to disrupt frame synchronization, essentially creating a fake pattern that confuses the receiver. ECLD/EDLC exploits weaknesses in error correction codes or sends bursts of errors to make the receiver accept corrupted data or fail to detect errors altogether. AM manipulates the signal strength (amplitude) of the entire data transmission, overpowering or interfering with the legitimate signal (including the RTT packet) and making it difficult for the receiver to decode the data correctly.

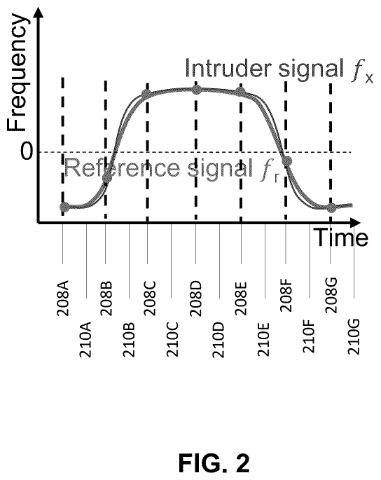

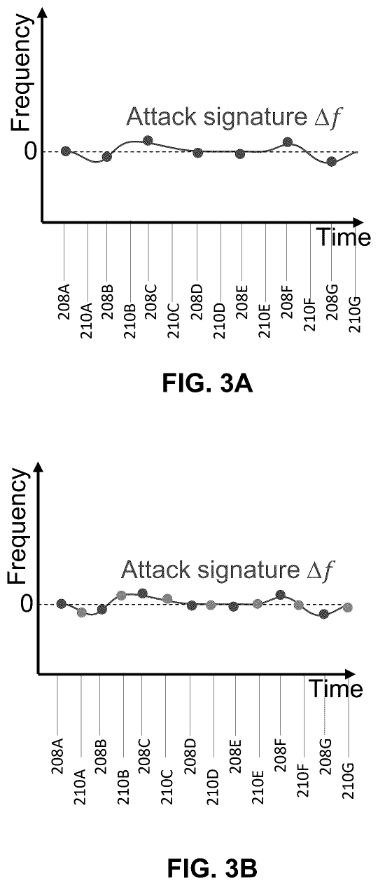

Detection techniques, used as a security measures, can identify the utilization of these spoofing techniques. Detection techniques sample the signal at regular intervals (sampling rate) to analyze its characteristics for attack signatures. As illustrated in FIG. 2, a received signal (e.g., intruder signal fₓ) and a reference signal fᵣ is sampled at times 208A-208G). Which can be a low sampling rate (e.g., 4 MHz) that distorts the attack signature (e.g., attack signature Δf). Attack signature Δf represents the difference between the intruder signal fₓ and the reference signal fᵣ (as shown in FIG. 3A) Due to fractional delays caused by low sampling rate, detection is challenging. Therefore, as illustrated in FIG. 2, the received signal (e.g., intruder signal fₓ) and reference signal fᵣ can be sampled at a higher sampling rate (e.g., at times 208A-208G and times 210A-210G). The high sampling rate is crucial to maintain clear attack signatures (as shown in FIG. 3B). However, a high sampling rate can also increase power consumption and memory utilization.

Accordingly, to resolve the security vulnerabilities associated with BLE distance estimation employing RTT-based ranging techniques and to improve attack detection, the present disclosure involves a transmitter (e.g., a transmission device) and a receiver, and related systems and methods, that utilizes, in the receiver, uses fractional timing associated with the fractional delay to adjust the correlation metric used for attack detection. For example, in some embodiments, a wireless device (e.g., a receiving device) includes receiving logic coupled to or integrated within a receiver of the wireless device.

This receiving logic may be stored with a set of coefficients associated with a function that calculates, using the fractional timing of a received signal, to determine a correlation metric adjustment value. In some embodiments, the set of coefficients may be calculated, during manufacturing, by providing a plurality of training signals to the receiver. Obtaining for each training signal of the plurality of training signals a fractional timing and a correlation metric of a respective the training signal (e.g., a data point). The set of coefficients is based on a function (e.g., a polynomial, or other method to fit curve including neural networks), that best approximates the set of data point. In some embodiments, during operation, fractional timing, and correlation metric of each received signal may be aggregated to assist in updating the set of coefficients or generation of the set of coefficients.

During operation, the receiving logic receives a signal (e.g., received signal). The receiving logic generates a reference signal. The receiving logic identifies a fractional timing of the received signal. The receiving logic, using the set of coefficients and the fractional timing, calculate a correlation metric adjustment value. The receiving logic calculates a correlation metric for the received signal and adjusts the correlation metric using the correlation metric adjustment value. The receiving logic, to determine whether the received signal contains an attack, compares the adjusted correlation metric with one or more thresholds associated with an attack.

The present disclosure includes a number of advantages, including introducing the use of fractional timing in calculating the correlation metric to minimize the impact of different fractional delays on an attack pattern. Accordingly, the present disclosure provides the ability to add additional aspects of security to distance estimations (e.g., the RTT-based ranging of BLE), which can be used to provide secure access to resources such as enclosures (e.g., a building or a vehicle), devices and/or device functionality, software, and any other resources to which any type of access or control is desired. In addition, the present disclosure involves small changes to existing infrastructure, thus avoiding the cost increases associated with other security techniques.

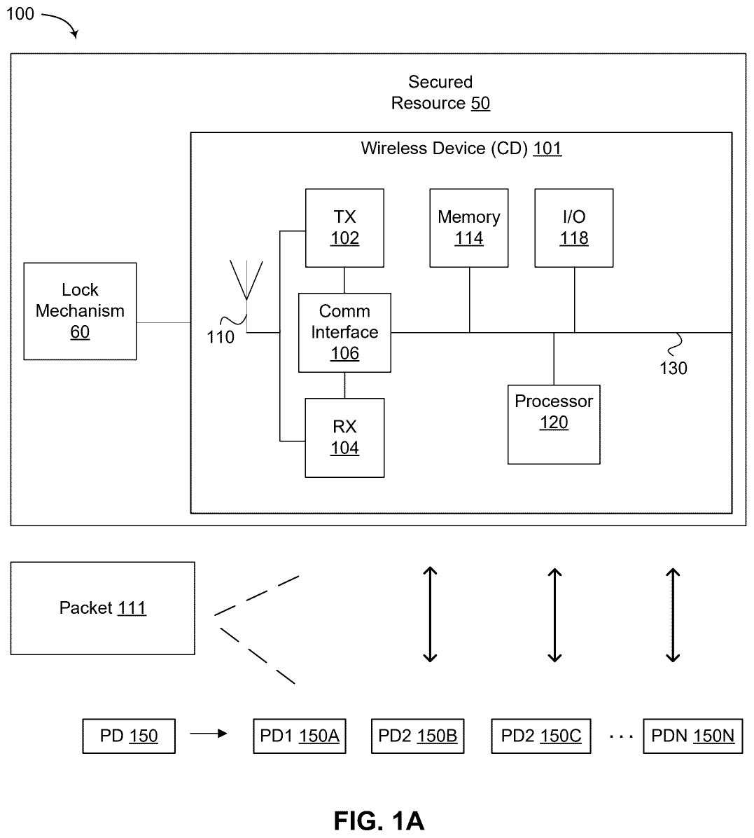

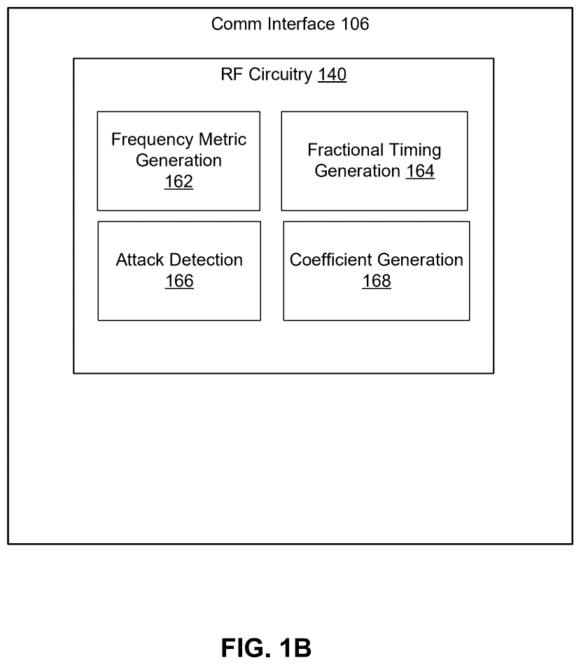

FIG. 1A is a block diagram of a system 100 useable for providing improved attack detection in round-trip timing (RTT) estimation between a wireless device 150 and a wireless device 101, according to an example embodiment. The wireless device 101 can act as a transmitter to set transmission time, and the wireless device 150 can act as a receiver, according to an example embodiment. In some embodiments, the wireless device 101 can act as a receiver to detect reception time, and the wireless device 150 can act as a transmitter. The difference between the reception time and the transmission time can be referred to as round-trip timing, which is described in further detail with respect to FIG. 1B. The system 100 can include a secured resource 50, e.g., that is secured using a lock mechanism 60, where the wireless device 150 is adapted to gain access to the secured resource 50 via the lock mechanism 60. The secured resource 50 can be, for example, an enclosure such as a vehicle, a building, a residence, a garage, a shed, a vault, or the like. The secured resource 50 can also be a computer system, industrial equipment, or other items requiring secured access via the lock mechanism 60, which can be a digital locking mechanism, for example. In some embodiments, the lock mechanism 60 is integrated together with the wireless device 101.

In various embodiments, the wireless device 150 is any one of multiple peripheral wireless devices PD1 150A . . . PDN 150N, as the wireless device 101 can be adapted to communicate with any or all of the peripheral wireless devices PD1 150A . . . PDN 150N. In differing embodiments, the wireless device 150 is a mobile device such as a mobile phone, a smart phone, a pager, an electronic transceiver, a tablet, or the like. In these embodiments, the wireless device 150 can be adapted to gain access to the secured resource 50 by transmitting data, including a frame delimiter and an enclosed frame. In some embodiments, the frame is encapsulated in a frame synch packet, and one or more frame synch packets 111 can be transmitted from the wireless device 150 to the wireless device 101. While the wireless device 101 is illustrated in detail, the wireless device 150 can also include the same or similar components as the wireless device 101, but are not repeated for simplicity. There can be transmission-reception symmetry between two wireless devices (however, the wireless device 150 is considered as a transmitter, and the wireless device 101 is considered as a receiver for simplification purposes).

In at least some embodiments, the wireless device 101 includes, but is not limited to, a transmitter 102 or TX (e.g., a PAN transmitter), a receiver 104 or RX (e.g., a PAN receiver), a communications interface 106, one or more antenna 110, a memory 114, one or more input/output (I/O) devices 118 (such as a display screen, a touch screen, a keypad, and the like), and a processor 120. These components can all be coupled to a communications bus 130.

In some embodiments, a separate antenna is employed for each of the transmitter 102 and receiver 104, and so the antenna 110 is illustrated for simplicity. In at least some embodiments, the memory 114 can include storage to store instructions executable by the processor 120 and/or data generated by the communication interface 106. In various embodiments, frontend components such as the transmitter 102, the receiver 104, the communication interface 106, and the one or more antenna 110 described herein within various devices may be adapted with or configured for PAN-based frequency bands, e.g., Bluetooth® (BT), BLE, Wi-Fi®, Zigbee®, Z-wave™, and the like.

In some embodiments, the communications interface 106 is integrated with the transmitter 102 and the receiver 104, e.g., as an RF front-end (RFFE) circuitry of the wireless device 101. The communication interface 106 may coordinate, as directed by the processor 120, to request/receive packets from the peripheral wireless device 150. The communications interface 106 can further process data symbols received by the receiver 104 in a way that the processor 120 can perform further processing, including verifying correlation between phase-based samples of data values obtained from a frame of a packet and an expected data pattern as part of a security protocol, as discussed herein.

FIG. 1B is a simplified block diagram of the communication interface 106 of the CD-based wireless device 101 of FIG. 1A, in accordance with some implementations.

In some embodiments, the communication interface 106 includes RF circuitry 140, although the RF circuitry 140 discussed herein may also be coupled with the communication interface 106 and thus be located elsewhere within the front-end of the wireless device 101. In some embodiments, the RF circuitry 140 includes (or is coupled with) a frequency metric generation 162, a fractional timing generation circuit 164, an attack detection circuit 166, and a coefficient generation circuit 168.

The frame synchronization pattern is a predefined sequence of bits or symbols that is unique and easily recognizable. It is known to both the transmitter and the receiver and is used to identify the beginning of a frame. The fractional timing generation circuit 164 derives a reference signal from the frame synchronization pattern. The reference signal is a signal that represents the frame synchronization pattern, processed (e.g., modulated) to match the format of the transmitted signal (e.g., received signal). The reference signal, used by the receiver, facilitates identification of the synchronization pattern in the incoming data. The fractional timing generation circuit 164 computes the cross-correlation with the received signal and the reference signal to identify potential synchronization points. Synchronization points indicate where the reference signal aligns with a segment of the received signal. Cross-correlation is a measure of similarity between two signals as a function of the time-lag applied to the received signal or the reference signal. The fractional timing generation circuit 164 locates the peak in the cross-correlation output, which indicates the presence of the frame synchronization pattern. The fractional timing generation circuit 164 determines, using interpolation around the detected peak (e.g., correlation peak), a fractional timing metric fracT (e.g., fractional timing offset).

The frequency metric generation 162 computes a correlation metric (e.g., a frequency metric) between an attack pattern p and a value representing a difference between the received signal and the reference signal (e.g., signal difference Δf). In some embodiments, the attack pattern p can be pre-computed and can be stored on the receiver and/or the transmission device. In some embodiments, the frequency metric generation 162 can receive the attack pattern p in an agreement transmitted to the receiver (e.g., transmitted from the transmission device). In some embodiments, the agreement can be another packet, a notification, message, etc., that includes information about the attack pattern, the frame synchronization pattern, and/or the predetermined pattern. For example, the frequency metric generation 162 can compute the correlation metric using an example mathematical equation, such as:

$$M = Δ f \cdot p ,$$

where M is the correlation metric, Δf is the vector representing the difference between received frequency samples and the frame synchronization pattern, and p is the attack pattern described above.

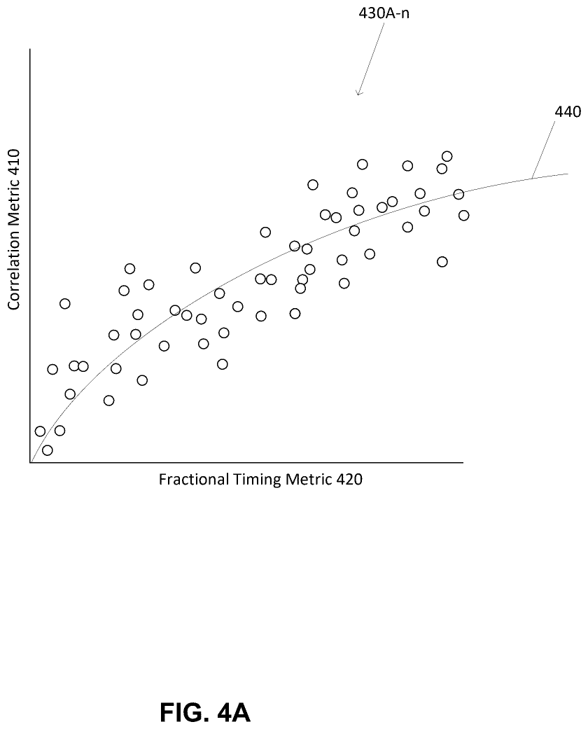

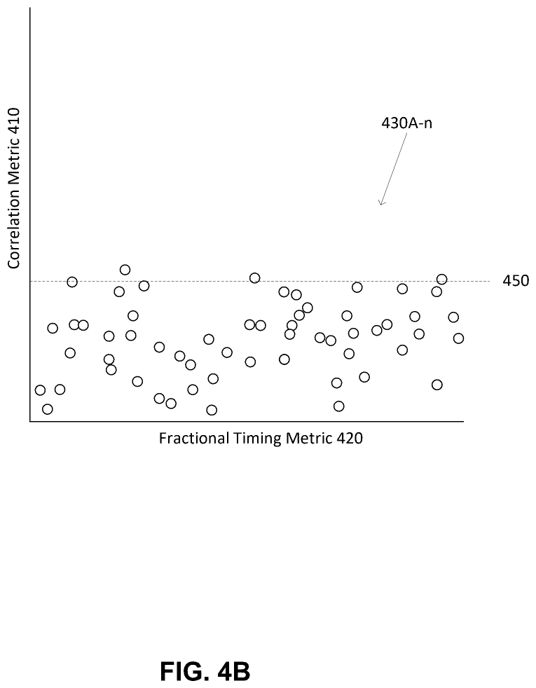

The frequency metric generation 162 may further adjust the correlation metric (e.g., M) using the fractional timing metric (e.g., fractional timing metric fracT). For example, the frequency metric generation 162 can adjust the correlation metric (e.g., M) using an example mathematical equation, such as:

$${M}^{′} = M - f ( fracT ) ,$$

where M′ is an adjusted correlation metric, M is the correlation metric, and f (fracT) may be a polynomial function that takes fracT as input and a correlation metric adjustment value as an output. f (fracT) may be defined by a set of coefficients (e.g., a0-an). For example, with quick reference to FIG. 4A, a correlation metric for a data point of a plurality of data points 430A-n is M. Once adjusted, the correlation metric (e.g., the adjusted correlation metric) for each data point of a plurality of data points 430A-n is changed from M to M′ (as shown in FIG. 4B). This provides the effect of flattening out the distribution of the data points. Accordingly, a threshold value 450 may be used to differentiate between a received signal with an attack and a received signal without an attack.

In some embodiments, the set of coefficients (e.g., a0-an) can be pre-computed by the coefficient generation circuit 168. With quick reference to FIG. 4A, a training signal may be received. The frequency metric generation 162 computes a correlation metric for the training signal, and fractional timing generation circuit 164 computes a fractional timing metric for the training signal. The correlation metric and the fractional timing metric are stored in a buffer, until a predetermined number of training signals have been received. In other words, the correlation metric and the fractional timing metric for a predetermined number of training signals has been computed. Thus, a training signal is continuously received, corresponding correlation metrics and fractional timing metrics are computed, and the corresponding correlation metrics and fractional timing metrics are computed is stored in the buffer.

Once the predetermined number of training signals have been received, for example, a set of coefficients of a polynomial that best approximates the data points is computed (e.g., updated set of coefficients). In other words, represents the relationship between the correlation metric of the data points and the fractional timing of the data points. More specifically, a degree for the polynomial may be decided, and a least square method may be used to compute the set of coefficients. In some embodiments, the correlation 410 and fractional timing 420 pair represents a data point of the plurality of data points 430A-n (e.g., the predetermined number of training signals). Curve 440 represents the polynomial function which best approximates the data points. The set of coefficients may be replaced with the updated set of coefficients.

The attack detection circuit 166 compares the adjusted correlation metric M′ to a threshold value. Accordingly, if the adjusted correlation metric M′ exceeds the threshold value a specific attack is detected (or present) in the received signal. For example, the comparison with multiple threshold values can be represented using an example mathematical expression, such as:

$${T}_{L} < M < {T}_{R}$$

where T_{L} is a lower threshold value and T_{R} is an upper threshold value. Accordingly, if the adjusted correlation metric M′ exceeds the upper threshold value T_{R} or falls below a lower threshold value T_{L}, a specific attack is detected in the received signal.

Depending on the embodiment, the coefficient generation circuit 168 may be used to obtain an adjusted threshold based on the relationship between the correlation metrics and the fracT. Accordingly, rather than adjusting the correlation metric, the comparison is performed with the adjusted threshold.

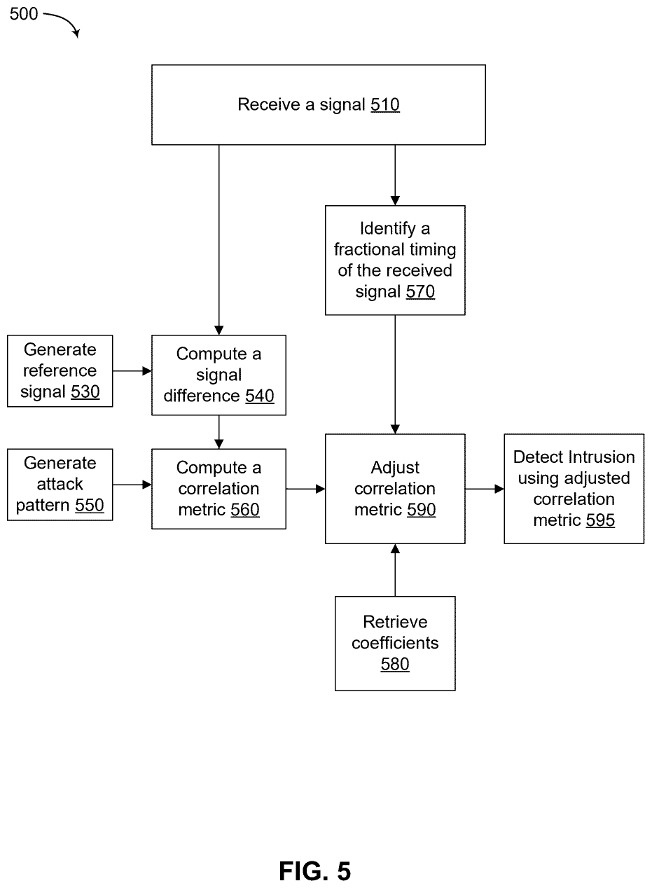

FIG. 5 is a flow diagram of a method 500 of performing attack detection in RTT using adjustable impulse response, according to various embodiments. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the receiver 104 (e.g., as illustrated in FIG. 1A).

At operation 510, the processing logic receives a signal. The signal is a transmitted signal from a transmitter. At operation 530, the processing logic generates reference signal. As previously described, the reference signal is derived from a frame synchronization (e.g., sequence of bits or symbols known to both the transmitter and receiver used to identify the start of a frame).

At operation 540, the processing logic computes a signal difference. As previously described, the signal difference is a difference between the received signal and the reference signal. At operation 550, the processing logic generates an attack pattern. At operation 560, the processing logic computes a correlation metric. As previously described, the correlation metric is calculated based on a product of the signal difference and the attack pattern.

At operation 570, the processing logic identifies a fractional timing of the received signal. As previously described, the fractional timing is calculated by performing a cross-correlation with the received signal to identify potential synchronization points. The location of the peak in the cross-correlation output indicates the presence of the frame synchronization pattern. The processing logic then uses interpolation around this peak to determine a fractional timing (e.g., fractional timing metric or fractional timing offset).

At operation 580, the processing logic retrieves a set of coefficients. As previously described, the set of coefficients may be precomputed based on correlation metric and the fractional timing for a set of training signals. More specifically, the set of coefficients is of a polynomial that best approximates the set of training signals (e.g., data points).

At operation 590, the processing logic adjusts correlation metric. To adjust the correlation metric, the processing logic calculates a correlation metric adjustment value by applying the set of coefficients to the fractional timing of the received transmitted signal. The processing logic then subtracts the correlation metric adjustment value from the correlation metric to generate the adjusted correlation metric. At operation 595, the processing logic detects an attack using adjusted correlation metric. As previously described, the processing logic detects an attack by comparing the adjusted correlation metric to one or more threshold values.

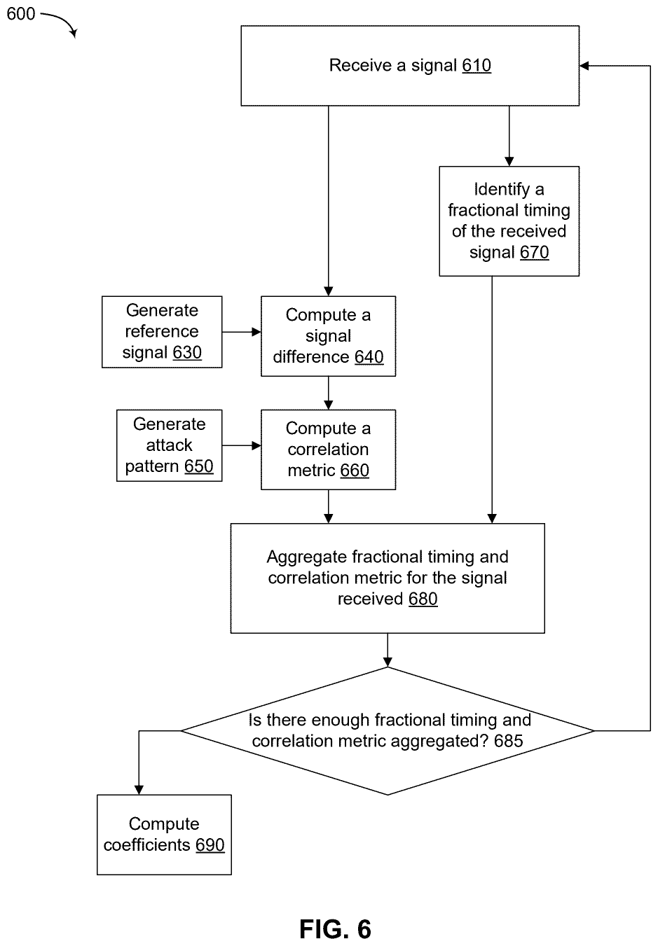

FIG. 6 is a flow diagram of a method 600 of performing attack detection in RTT using adjustable impulse response, according to various embodiments. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the receiver 104 (e.g., as illustrated in FIG. 1A).

At operation 610, the processing logic receives a signal. As previously described, the signal is a training signal used to generate the set of coefficients. At operation 630, the processing logic generates reference signal. As previously described, the reference signal is derived from a frame synchronization (e.g., sequence of bits or symbols known to both the transmitter and receiver used to identify the start of a frame).

At operation 640, the processing logic computes a signal difference. As previously described, the signal difference is a difference between the received signal and the reference signal. At operation 650, the processing logic generates an attack pattern. At operation 660, the processing logic computes a correlation metric. As previously described, the correlation metric is calculated based on a product of the signal difference and an attack pattern. The attack pattern may be pre-computed.

At operation 670, the processing logic identifies a fractional timing of the received signal. As previously described, the fractional timing is calculated by performing a cross-correlation with the received signal to identify potential synchronization points. The location of the peak in the cross-correlation output indicates the presence of the frame synchronization pattern. The processing logic then uses interpolation around this peak to determine a fractional timing (e.g., fractional timing metric or fractional timing offset).

At operation 680, the processing logic aggregates (or maintains) fractional timing and correlation metric for the received signal. As previously described, the fractional timing and correlation metric associated with the received signal is stored in a buffer, until a predetermined number of training signals have been received. In other words, the correlation metric and the fractional timing metric for a predetermined number of training signals has been computed. At operation 685, the processing logic determines whether enough fractional timing and correlation metric is aggregated.

If a predetermined number of training signal has not been received, the processing logic proceeds to operation 610. In other words, training signals are continuously received until the predetermined number of training signal has been received.

Otherwise, if the predetermined number of training signal has been received, the processing logic proceeds to operation 690. Responsive to determining that enough fractional timing and correlation metric has been aggregated, the processing logic, at operation 690, computes the set of coefficients. As previously described, for example, the set of coefficients is identified for a polynomial that best approximates the set of training signals (e.g., data points). The set of coefficients is stored for later use with the fractional timing of a received signal to adjust the correlation metric of the received signal.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments, the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A wireless device comprising:
a receiver adapted with Bluetooth® low energy (BLE) capability; and
logic at least one of coupled to or integrated within the receiver, wherein the logic is to perform operations comprising:
receiving a signal;
identifying, based on the received signal and a reference signal, a fractional timing metric associated with the received signal;
calculating, based on the received signal, the reference signal, and an attack pattern, a correlation metric;
adjusting, based on the fractional timing metric, the correlation metric; and
determining, based on the adjusted correlation metric and one or more thresholds, whether an attack is present in received signal.

2. The wireless device of claim 1, wherein determining, based on the adjusted correlation metric and one or more thresholds, whether the attack is present in received signal comprises:
comparing the adjusted correlation metric to the one or more thresholds.

3. The wireless device of claim 1, wherein identifying the fractional timing metric comprises:
generating the reference signal;
computing a cross-correlation with the received signal and the reference signal;
identifying, from the cross-correlation, a plurality of correlation peak; and
determining, using the plurality of correlation peak, the fractional timing metric.

4. The wireless device of claim 1, wherein calculating the correlation metric comprises:
calculating a difference between the received signal and the reference signal to generate a signal difference; and
calculating, using the signal difference and the attack pattern, the correlation metric.

5. The wireless device of claim 1, wherein adjusting, based on the fractional timing metric, the correlation metric comprises:
computing, based on a set of coefficients and the fractional timing metric, a correlation metric adjustment value; and
adjusting, based on the correlation metric adjustment value, the correlation metric.

6. The wireless device of claim 5, wherein generating the set of coefficients comprises:
receiving a plurality of training signals;
identifying, based on a reference signal, a fractional timing metric for each training signal of the plurality of training signals;
calculating, based the reference signal, a correlation metric for each training signal of the plurality of training signals; and
identifying the set of coefficients that represent a relationship between the fractional timing metric and the correlation metric for each training signal of the plurality.

7. The wireless device of claim 5, further comprising:
computing the fractional timing metric and the correlation metric for each received signal;
responsive to determining that the fractional timing metric and the correlation metric for a predetermined number of received signals is computed, identifying an updated set of coefficients that represent a relationship between the fractional timing metric and the correlation metric for each received signal; and
replacing the set of coefficients with the updated set of coefficients.

8. A method comprising:
receiving a signal;
identifying, based on the received signal and a reference signal, a fractional timing metric associated with the received signal;
calculating, based on the received signal, the reference signal, and an attack pattern, a correlation metric;
adjusting, based on the fractional timing metric, the correlation metric; and
determining, based on the adjusted correlation metric and one or more thresholds, whether an attack is present in received signal.

9. The method of claim 8, wherein determining, based on the adjusted correlation metric and one or more thresholds, whether the attack is present in received signal comprises:
comparing the adjusted correlation metric to the one or more thresholds.

10. The method of claim 8, wherein identifying the fractional timing metric comprises:
generating the reference signal;
computing a cross-correlation with the received signal and the reference signal;
identifying, from the cross-correlation, a plurality of correlation peak; and
determining, using the plurality of correlation peak, the fractional timing metric.

11. The method of claim 8, wherein calculating, based on the received signal and the reference signal, the correlation metric comprises:
calculating a difference between the received signal and the reference signal to generate a signal difference; and
calculating, using the signal difference and the attack pattern, the correlation metric.

12. The method of claim 8, wherein adjusting, based on the fractional timing metric, the correlation metric comprises:
computing, based on a set of coefficients and the fractional timing metric, a correlation metric adjustment value; and
adjusting, based on the correlation metric adjustment value, the correlation metric.

13. The method of claim 12, wherein generating the set of coefficients comprises:
receiving a plurality of training signals;
identifying, based on a reference signal, a fractional timing metric for each training signal of the plurality of training signals;
calculating, based the reference signal, a correlation metric for each training signal of the plurality of training signals; and
identifying the set of coefficients that represent a relationship between the fractional timing metric and the correlation metric for each training signal of the plurality.

14. The method of claim 12, further comprising:
computing the fractional timing metric and the correlation metric for each received signal;
responsive to determining that the fractional timing metric and the correlation metric for a predetermined number of received signals is computed, identifying an updated set of coefficients that represent a relationship between the fractional timing metric and the correlation metric for each received signal; and
replacing the set of coefficients with the updated set of coefficients.

15. A system comprising:
an antenna;
a transmission device that is to transmit a packet;
a receiving device adapted with Bluetooth® low energy (BLE) capability; and
logic at least one of coupled to or integrated with the receiver, the logic is to perform operations comprising:
receiving a signal;
identifying, based on the received signal and a reference signal, a fractional timing metric associated with the received signal;
calculating, based on the received signal, the reference signal, and an attack pattern, a correlation metric;
adjusting, based on the fractional timing metric, the correlation metric; and
determining, based on the adjusted correlation metric and one or more thresholds, whether an attack is present in received signal.

16. The system of claim 15, wherein determining, based on the adjusted correlation metric and one or more thresholds, whether the attack is present in received signal comprises:
comparing the adjusted correlation metric to the one or more thresholds.

17. The system of claim 15, wherein identifying the fractional timing metric comprises:
generating the reference signal;
computing a cross-correlation with the received signal and the reference signal;
identifying, from the cross-correlation, a plurality of correlation peak; and
determining, using the plurality of correlation peak, the fractional timing metric.

18. The system of claim 15, wherein adjusting, based on the fractional timing metric, the correlation metric comprises:
computing, based on a set of coefficients and the fractional timing metric, a correlation metric adjustment value; and
adjusting, based on the correlation metric adjustment value, the correlation metric.

19. The system of claim 18, wherein generating the set of coefficients comprises:
receiving a plurality of training signals;
identifying, based on a reference signal, a fractional timing metric for each training signal of the plurality of training signals;
calculating, based the reference signal, a correlation metric for each training signal of the plurality of training signals; and
identifying the set of coefficients that represent a relationship between the fractional timing metric and the correlation metric for each training signal of the plurality.

20. The system of claim 18, wherein the logic is to perform operations further comprising:
computing the fractional timing metric and the correlation metric for each received signal;
responsive to determining that the fractional timing metric and the correlation metric for a predetermined number of received signals is computed, identifying an updated set of coefficients that represent a relationship between the fractional timing metric and the correlation metric for each received signal; and
replacing the set of coefficients with the updated set of coefficients.
